(19) United States
(12) Patent Application Publication
(10) Pub. No.: US 2007/0291947 A1
(43) Pub. Date: Dec. 20, 2007

(54) Cryptographically controlled radio transmitter and receiver

(76) Inventor: David M. Theobold, Akron, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/811,123

(22) Filed: Jun. 9, 2007

Related U.S. Application Data
(60) Provisional application No. 60/814,795, filed on Jun. 19, 2006.

(51) Int. Cl. H04K 1/00

(52) U.S. Cl. 380/274

(57) ABSTRACT

A cryptographically controlled transmitter/receiver having transmission characteristics comprising a media access control layer having one or more media access parameters, a physical layer having one or more physical parameters, a radio frequency layer having one or more radio frequency parameters, a code generator configured to generate and send code words to at least one of the media access control layer, the physical layer, and the radio frequency layer, wherein at least one of the layers is configured to transmit and receive data and at least one of the other the layers is configured to input and output the data, and wherein at least one media access parameter, physical parameter, or radio frequency parameter is modified upon the receipt of the code.

### CROSS REFERENCE TO RELATED APPLICATION

This application claims priority of U.S. provisional application Ser. No. 60/814,795 filed Jun. 19, 2006, and which is incorporated herein by reference.

### TECHNICAL FIELD

The present invention generally relates to a transmitter and a receiver for the communication of data. More specifically, the present invention relates to a transmitter and a receiver, wherein the modulation characteristics of a transmitted signal are varied in accordance with a code word. Additionally, the present invention relates to a synchronized transmitter and a receiver pair such that the code word can be shared between the transmitter and receiver to enable transmission of data therebetween.

### BACKGROUND

Current efforts directed to securing the data communications between a transmitter and receiver fall into two categories: encryption/decryption and spectral spreading. In the case of data encryption/decryption, the imposed data is encoded using an algorithm, and then transmitted. Once transmitted, the encrypted data is received at the receiver where the data is decoded into a usable form. Thus, from a data security view, the particular process used in encoding and decoding the data completely defines the effectiveness of the system to secure the transmitted data, as it is assumed that an unintended listener has the capability to receive the encoded data. In other words, the strength of this system in securing transmitted data is reliant on the inability of an interloper to break the encryption. However, data encryption methods currently utilized suffer from the fact that the transmitted encrypted data can be readily received by a receiver configured to receive the signal carrying the encrypted data. Thus, given enough time, it is generally assumed that a motivated interloper, using known techniques, can break the encryption used to secure the transmitted data.

An alternative method for securing transmitted data is referred to as spectral spreading. Securing transmitted data using spectral spreading involves using a compatible transmitter that is capable of spectral spreading, and a receiver that is capable of spectral despreading. Spectral spreading utilizes spreading codes that configure the transmitter, and dictate how the data may be apportioned with respect to time-domain spreading, frequency-domain spreading, or a combination thereof. Correspondingly, the spreading codes are known by the intended receiver so that the imposed data can be recovered. Because the data is not encrypted prior to being transmitted, the security of this method is defined by the performance of the spectral spreading process. Thus, in order to receive the transmitted data, the unintended listener must have knowledge of the spreading codes that are used by the transmitter. However, even without the spreading codes, wide-bandwidth receivers may be utilized to receive the transmitted spread spectrum signal, and given enough time a motivated interloper, using known techniques, can break the spreading codes used to secure the transmitted data.

To overcome the deficiencies apparent in each of the methods presented, attempts have been made to combine each of the approaches. However, such systems still suffer from the disadvantages discussed above.

Therefore, there is a need for a cryptographically controlled transmitter and receiver that conveys encrypted or plain text data therebetween. Furthermore, there is a need for a cryptographically controlled transmitter that is capable of modifying the modulation specifications of the transmitted signal on a frame-by-frame basis. In addition, there is a need for a cryptographically controlled transmitter and receiver that utilizes a code generator that generates a code word that is used to modify the data communication specifications of the components of the transmitter and receiver. Still yet, there is a need for a code generator that is synchronized between the cryptographically controlled transmitter and receiver to coordinate the sharing of the generated code word, so that the transmitted data can be recovered by the receiver.

### SUMMARY OF THE INVENTION

In light of the foregoing, it is a first aspect of the present invention to provide a cryptographically controlled radio transmitter and receiver.

It is another aspect of the present invention to provide a cryptographically controlled transmitter/receiver having transmission characteristics comprising a media access control layer having one or more media access parameters, a physical layer having one or more physical parameters, a radio frequency layer having one or more radio frequency parameters, a code generator configured to generate and send code words to at least one of the media access control layer, the physical layer, and the radio frequency layer, wherein at least one of the layers is configured to transmit and receive data and at least one of the other layers is configured to input and output the data, and wherein at least one media access parameter, physical layer parameter, or radio frequency parameter is modified upon the receipt of the code.

Yet another aspect of the present invention is to provide a cryptographically controlled communication system comprising a first cryptographically controlled radio (CCR) configured to transmit, the first CCR maintaining a media access control (MAC) layer, a physical (PHY) layer, and a radio frequency (RF) layer each having one or more data communication specifications, and a second CCR configured to receive, the second CCR maintaining a media access control (MAC) layer, a physical (PHY) layer, and a radio frequency (RF) layer each having one or more data communication specifications, the first and the second CCR synchronously generating at least one code word, wherein the generation of code words results in the modification of at least one of the data communication specifications maintained by one of the MAC, PHY, and RF layers maintained by both the first and the second CCR.

### BRIEF DESCRIPTION OF THE DRAWINGS

These and other features and advantages of the present invention will become better understood with regard to the following description, appended claims, and accompanying drawings wherein:

FIG. 1 is a block diagram showing a data communications system according to the concepts of the present invention comprising a cryptographically controlled transmitter and receiver that are each controlled by time and key references that are shared between each transmitter/receiver pair; and

FIG. 2 is a block diagram showing the cryptographically controlled transmitter/receiver having various data communication specifications, which are controlled by a code word output by a code generator.

### BEST MODE FOR CARRYING OUT THE INVENTION

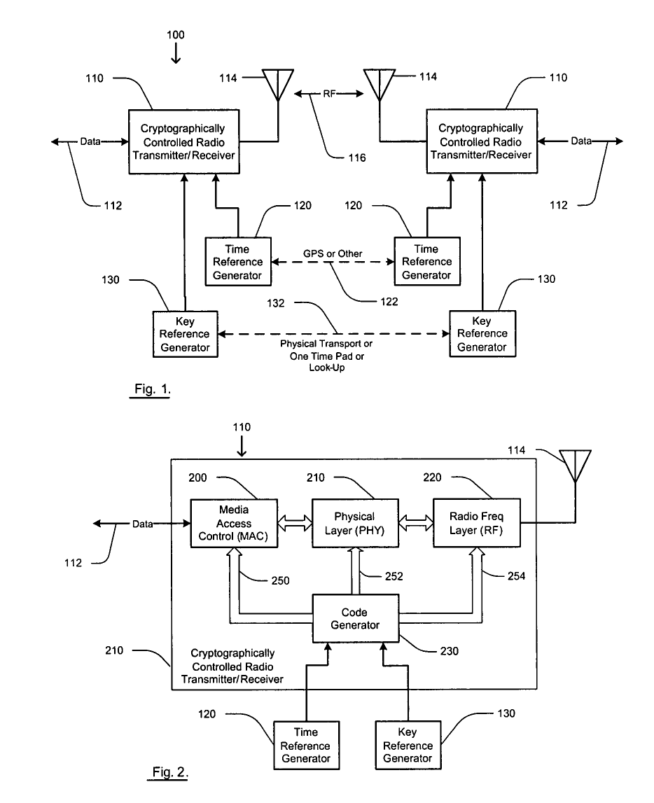

A cryptographically controlled radio system according to the concepts of the present invention is generally designated by the numeral 100 as shown in FIG. 1 of the drawings. The system 100 comprises a pair of cryptographically controlled radios or CCR 110 which send and/or receive bidirectional data streams at their respective data inputs/outputs 112. For the purposes of the following discussion, the term radio is defined as a system that is able to both transmit and/or receive various data signals. In other words, each CCR 110 is capable of transmitting and receiving signals when used according to the concepts to be discussed. The transmitter/receivers 110 each provide an antenna 114 that defines the radio frequency (RF) propagation interface 116, where the transmitted RF signals propagate in space. Each antenna 114 is configured to send and receive a wide band of frequencies necessary for the operation of the system 100. While the present invention contemplates the use of RF signals to transmit data between the transmitter/receivers 110, such should not be construed as limiting as other communication mediums utilizing other frequency spectrums may be utilized, for example baseband or light or acoustic transmission mediums may be utilized.

Coupled to each CCR 110 is a time reference generator 120. In order to synchronize each of the time reference generators 120 associated with each transmitter/receiver 100, a time synchronization signal 122 provided by a Global Positioning System (GPS), a precision clock, or other suitable synchronization method may be utilized. Additionally, a key reference generator 130 is coupled to each CCR 110 and supplies a key reference thereto. The key reference may be shared between each of the CCR 110 via a physical transport 132, or may be supplied in other manners such as by a one-time pad, or look-up mechanism or other secure transmission method.

FIG. 2 shows a single cryptographically controlled radio (CCR) 110, assumed to be in a transmitting state for the purpose of the following discussion. The CCR 110 comprises a media access control (MAC) 200 that is coupled between the data input/output 112 and a physical layer (PHY) 210. The media access control 200 provides protocol, framing, buffering, and a timing interface to the baseband data supplied to the data input 112 of the CCR 110. The data frames generated by the media access control layer 200 are processed by the physical layer 210, such that a preamble is added to each data frame. The physical layer 210 also controls a modulation format that is utilized by each incoming data frame received from the media access control 200. Coupled to the output of the physical layer 210 is a radio frequency (RF) layer 220. The radio frequency layer 220 provides frequency control, upconversion, and amplification of the framed data. Because the CCR 110 functions as a transmitter and a receiver, the data movement between the MAC, PHY, and RF layers 200-220 is bidirectional. When the CCR 110 is in a receiving state, signals received at the antenna 114 are passed to the radio frequency layer 220, upon which low noise amplification, filtering, and downconversion are performed. After the received signal has been processed by the radio frequency layer 220, the physical layer 210 detects and demodulates the received signal. Finally, the received signal is processed by the media access control 200 where each transmitted data frame contained in the transmitted signal is returned to a baseband data stream at the output 112.

A code generator 230 is coupled to the media access control layer 200, the physical layer 210, and the radio frequency layer 220. The code generator 230 utilizes the time reference signal from the time reference generator 120 to remain frame synchronized with one or more other cryptographically controlled radios (CCR) 110 that are in communication therewith. In addition, the code generator 230 utilizes the key reference from the key reference generator 130 to generate pseudo-random code words 250, 252, and 254 that are sent to the media access control layer 200, the physical layer 210, and the radio frequency layer 220 respectively. Each of these pseudo-random code words 250, 252, and 254 are used to modify one or more data communication specifications maintained by each media access control layer 200, physical layer 210, and radio frequency layer 220. These data transmission specifications are related to the particular data processing standards or parameters employed by each of the layers when processing the baseband data for transmission, and inversely, for de-processing the transmitted signal back into the original baseband data. Thus, by reconfiguring the data communication specifications associated with each CCR 110 used on a changing basis, the probability of an unintended listener receiving the transmitted data signal are minimized.

Returning to FIG. 1, in order to transmit data from one CCR 110 to another CCR 110, the time reference generators 120 associated with each CCR 110 are initially synchronized, so as to enable synchronous generation of code words by each code generator 230. For example, code words may be generated for each frame of transmitted data, thus requiring each transmitting and receiving CCR 110 to have knowledge of particular code words 250-254 being utilized, so that the MAC, PHY, and RF layers 200-220 of both the transmitting and receiving CCR 110 are configured with the same code word. This allows the transmitted baseband data to be recovered at the receiving CCR 110. Once synchronized, the transmitting CCR 110 initiates the processing of the baseband data from a desired data source, typically on a frame-by-frame basis. For each frame, the code words 250-254 are generated by the synchronized code generator 230, and are supplied to the respective media access control 200, the physical layer 210, and the radio frequency layer 220. It should be appreciated that the codes words 250-254 may be of a sufficient length to specify the operation of the media access control 200, the physical layer 210, and the radio frequency layer 220 for the particular data frame being processed. And thus, for each subsequent data frame, the process is repeated. Accordingly, a new set of code words 250-254 are generated, and supplied to the MAC, PHY, and RF layers 200-220 where the operational specifications are correspondingly changed. Finally, when the data is finished being processed by the transmitting CCR 110, the data is transmitted via the antenna 114 to the receiving CCR 110. The receiving CCR 110, due to its frame synchronization with the transmitting CCR 110, performs the inverse processing associated with the code words 250-254 relating to the specific frame being deprocessed. It will be appreciated that the total number of codes that may comprise code words 250-254 is large, thus making it very difficult for an unintended listener to successfully receive and process the baseband data.

The data communication specifications provided by the layers may be modified by the pseudo-random code words. The modifications can be applied to any one or conceivably all of the layers 200, 210 and 220. Specifically, the modifications dynamically change an operating characteristic of a selected layer to facilitate secure communications within the system. The following characteristics may be changed:

Guard Interval—The guard interval is defined by RF communication standards, and is necessary for protocol control in order to maintain radio interoperability. By modifying the guard interval on a pseudo-random basis via the code generator 230, non-cooperating equipment is rendered incompatible with the modified protocol.

Training Field Symbol Constellation Positions—The training field symbol constellation positions may be changed in accordance with the pseudo-random code words 250-254. By doing such, the detection of the transmitted data packets would be made more difficult, and would prevent channel estimation by an unintended listener that does not have knowledge of the transmitted symbol constellation positions.

I/Q Swap—The in-phase and quadrature vector positions of any defined constellation may be interchanged. Communication standards relating to quadrattice amplitude modulation (QAM) define the order of the in-phase and quadrature components of the modulation. The code generator 230 can readily swap the I/Q definitions on a pseudo-random binary basis, rendering all subsequent demodulation operations ambiguous.

Scrambler Seed—The scrambler definition is yet another data communication specification that can be modified in accordance with the code words 250-254. The scrambler definition is obtained by standards documentation. However, the code generator 230 would be able to easily select another definition of the seed.

Phase Shifts per Subcarrier throughout Packet—The subcarrier phase variation is predominantly linear with frequency as a result of clock frequency errors. Adding a per subcarrier random phase shift that varies on a per orthogonal frequency division multiplexing (OFDM) symbol, would give the appearance of a non-linear phase variation versus frequency, which would invalidate the conventional approaches used to track these errors. Even without clock frequency errors, properly recovering the symbols would require prior knowledge of the phase rotation per subcarrier.

Frequency Offset Variation per Symbol—The orthogonality of OFDM is lost if there is an uncompensated frequency offset between the transmitter and receiver embodied by a pair of CCRs 110. This results in inter-carrier interference and makes demodulating the packet impossible if the frequency offset is too great. It is typically assumed that the frequency offset is approximately constant throughout the course of the packet. It is possible to digitally apply a frequency offset per OFDM symbol. The intended receiver would know what the per symbol frequency offset was and compensate accordingly. Tile unintended receiver would have to determine the frequency offset per OFDM symbol in some manner with very limited information in order to recover the transmitted symbols.

Carrier Frequency—The carrier frequency used by the radio frequency layer 220 during transmission is generally defined by standards that vary by geographical region. However, if maintained within the allocated band, the code generator 230 may select a carrier frequency in a varying manner via the code words 250-254.

Interleaver parameters—Interleaver design is also generally defined by communications standards. The functional block generating the interleaving function could have other linear definitions driven by the code generator 230.

Modulation Constellation Map—The code generator 230 can produce a constellation map that looks unlike a quadrature amplitude modulation (QAM) map, but still provides equivalent performance. Typically, a constellation map is selected based upon the largest Euclidean separation of the map vectors, but a relaxed selection might be tolerable for high energy per bit per noise power spectral density (Eb/No) situations.

Subcarrier Number and Value—Subcarrier number and hence value or position are determined by communication standards. Thus deviating from that standard by a code determined position complicates demodulation considerably.

Convolutional Coder Generating Polynomials—The coefficients for the convolutional coder/decoder could be selected on a pseudo-random basis. As such, this adds a highly nonlinear characteristic to the modulation, which would make the decoding difficult.

Training Symbol and Signal Field Positions within Packet—The short training field should always lead the packet if a real time automatic gain control (AGC) is employed. A training field is generally a predefined, fixed, easily correlated data or vector sequence by which a receiver derives critical timing/phase information. As long as this constraint is met where needed, the training symbols, and the signal field could be placed at arbitrary positions within the packet with no performance degradation, other than possible increased latency. If the training field used constellation points that matched the modulation used for the data, it would be impossible to distinguish the training symbols from the data symbols.

Encode/Decode in Forward or Inverse Time—The data packet could be generated and then transmitted by a CCR 110 using either a last-in first-out (LIFO) or a first-in first-out (FIFO) buffer. At the receiving CCR 110, the same type of buffer would be used prior to demodulation. Such time shifting could be employed either throughout a particular frame or randomly in subframe blocks throughout the frame. Hence, the inherent time order of the modulation and data would be rendered ambiguous to an interloper.

It will, therefore, be appreciated that one advantage of one or more embodiments of the present invention is that a cryptographically controlled transmitter can transmit data without using a spread spectrum while maintaining security of the transmitted data. Still another advantage of the present invention is that the cryptographically controlled transmitter and receiver system may use code words that can be used to modify one or more data communication specifications associated with the MAC, PHY, and RF layers 200-220. Yet another advantage of the present invention is that multiple cryptographically controlled radios are able to be time synchronized on a per frame basis. Another advantage of the present invention is that the cryptographically controlled radio may utilize long code words.

Although the present invention has been described in considerable detail with reference to certain embodiments, other embodiments are possible. Therefore, the spirit and scope of the appended claims should not be limited to the description of the embodiments contained herein.

What is claimed is:

1. A cryptographically controlled transmitter/receiver having transmission characteristics comprising:
a media access control layer having one or more media access parameters;
a physical layer having one or more physical parameters;
a radio frequency layer having one or more radio frequency parameters;
a code generator configured to generate and send code words to at least one of said media access control layer, said physical layer, and said radio frequency layer, wherein at least one of said layers is configured to transmit and receive data and at least one of the other said layers is configured to input and output said data., and wherein at least one media access parameter, physical layer parameter, or radio frequency layer parameter is modified upon the receipt of said code.

2. The transmitter/receiver according to claim 1, wherein each said layer is coupled to at least one of the other said layers.

3. The transmitter/receiver according to claim 2, further comprising:
an antenna coupled to said radio frequency layer for transmitting and receiving said data.

4. The transmitter/receiver according to claim 2, further comprising:
a time reference generator coupled to said code generator.

5. The transmitter/receiver according to claim 2, further comprising:
a key reference generator coupled to said code generator.

6. A cryptographically controlled communication system comprising:
a first cryptographically controlled radio (CCR) configured to transmit, said first CCR maintaining a media access control (MAC) layer, a physical (PHY) layer, and a radio frequency (RF) layer each having one or more data communication specifications; and
a second CCR configured to receive, said second CCR maintaining a media access control (MAC) layer, a physical (PHY) layer, and a radio frequency (RF) layer each having one or more data communication specifications, said first and said second CCR synchronously generating at least one code word;
wherein the generation of code words results in the modification of at least one of said data communication specifications maintained by one of said MAC, PHY, and RF layers maintained by both said first and said second CCR.
